(19) United States
(12) Patent Application Publication
(10) Pub. No.: US 2011/0174844 A1
(43) Pub. Date: Jul. 21, 2011

(54) Closure

(76) Inventor: Derek John Hindle, Norwich (GB)

(21) Appl. No.: 13/065,791

(22) Filed: Mar. 29, 2011

Related U.S. Application Data
(63) Continuation of application No. PCT/GB2009/002323, filed on Sep. 29, 2009.

(30) Foreign Application Priority Data
Oct. 1, 2008 (GB) GB 0817923.6

(51) Int. Cl. B67D 3/00

(52) U.S. Cl. 222/528; 222/531; 222/532

(57) ABSTRACT

A dispensing closure is provided and comprises a base having a dispensing orifice, in which the orifice is defined by a deformable dispensing member. The dispensing member is movable from an open, dispensing position to a closed, occluded position, and the base is operable to move the dispensing member between the dispensing and occluded positions.

### PRIORITY CLAIM

This application is a continuation of and claims priority under 35 U.S.C. §120 and/or 35 U.S.C. §365 to co-pending PCT Application No. PCT/GB2009/002323 having an international filing date of Sep. 29, 2009, which claims priority to Great Britain Application No. 0817923.6 filed on Oct. 1, 2008.

### FIELD OF THE INVENTION

The present invention relates generally to a closure and particularly to a dispensing closure.

### RELATED ART

In order for a dispensing closure to function successfully, it is important that on the one hand a good seal can be established to prevent product from leaking and on the other hand that moving the closure from a sealed to a dispensing position is made simple for a user.

### SUMMARY

According to a first aspect of the present invention there is provided a dispensing closure comprising a base having a dispensing orifice, in which the orifice is defined by a deformable dispensing member, in which the dispensing member is movable from an open, dispensing position to a closed, occluded position, and in which the base is operable to move the dispensing member between the dispensing and occluded positions.

The present invention therefore requires intervention from the user to move the dispensing member between the dispensing and occluded positions, which improves the ease of use. Furthermore, in some embodiments this may allow for some degree of flow regulation by the user if required.

The dispensing member may be relaxed in the open position and moveable to the closed position by deformation. Alternatively, the dispensing member may be relaxed din the closed position and moveable to the open position by deformation. Depending on the nature of the product, the method of use and the nature of material from which the dispensing member is formed, it may be preferable for the dispensing member to be in the closed position when relaxed to reduce stresses within the material when the closure and an associated container are stored.

The base may be rotatable relative to the dispensing member to move it between the dispensing and occluded positions. Rotation is a relatively simple action for a user and reduces the risk of problems when used by the young, elderly or infirmed.

The base may include one or more ramps for causing the dispensing member to move between the dispensing and occluded positions. The base may include an aperture through which the dispensing member extends. The dimensions of the aperture relative to the dispensing member may be variable by selecting a non-circular aperture shape.

The closure may further comprise a lid, which may be hinged to the base. The lid can be used to provide extra protection against product leakage and to reduce the risk of contamination of the dispensing member.

The dispensing member may comprise a spout. An elongate tube-like spout is a convenient configuration for a deformable structure.

The orifice may be sealed in the closed position. The seal may be provided by the nature of the material from which the dispensing member is formed.

The dispensing member may be formed separately from the base. Alternatively the dispensing member may be formed as an integral part of the base.

The dispensing member may be formed from an elastomeric material, such as a thermoplastic elastomer. Such materials provide a degree of resilience which is required for a deformable dispensing member.

According to a further aspect of the present invention there is provided a container having a closure as described herein.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views. The present invention will now be more particularly described, by way of example, with reference to the accompanying drawings, in which:

FIG. 1 is a perspective view of a closure formed according to an embodiment of the present invention and shown with a lid in a closed position;

FIG. 2 is a section of the closure of FIG. 1;

FIG. 3 is a perspective view of the closure of FIGS. 1 and 2 shown with a lid in an open position and a dispensing member in an occluded position;

FIG. 4 is a plan view of the closure of FIG. 3;

FIG. 5 is a perspective view of the closure of FIGS. 1 and 2 shown with the lid in an open position and the dispensing member in a dispensing position; and

FIG. 6 is plan view of the closure of FIG. 5.

### DETAILED DESCRIPTION

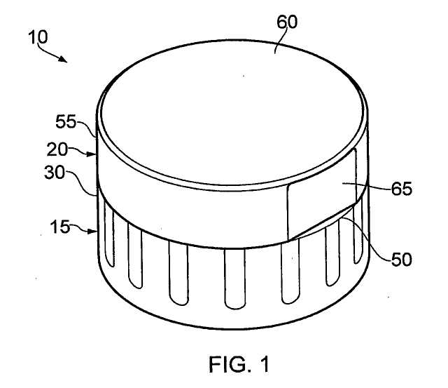

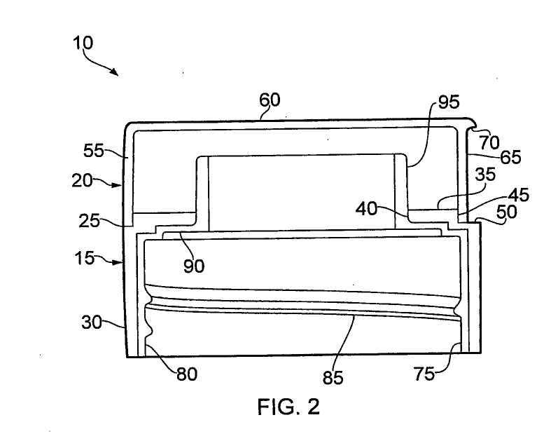

Referring first to FIGS. 1 and 2 there is shown a closure generally indicated 10. The closure comprises a generally cylindrical body having a base 15 and a lid 20 joined together by a hinge 25.

The base 15 comprises a generally cylindrical sidewall 30 partially closed at one end by a top deck 35.

The top deck is generally circular and has a central aperture 40 described in more detail below. Opposite the hinge 25, the top deck 35 has a flat 45 defining a step 50 on the sidewall 30.

The lid 20 comprises a generally cylindrical sidewall 55 closed at its end opposite the base by a disc-shape top plate 60.

Opposite the hinge 25 the sidewall 55 has a flat 65 which comes to rest on the base step 50 and defines a peak 70 on the top plate 60. The flat 65 therefore defines a pressing zone for flipping open the lid 20. The flat 65 and the flat 45 are formed to give an interference fit which holds the lid firmly on the base. In other embodiments (not shown) a catch, latch or the like is provided for holding the lid firmly in the closed position. Tamper-evidence means (not shown) may also be provided for showing the closure 10 has be opened at least once.

Fitted within the base 15 is an inner closure member generally indicated 75 and best shown in FIG. 2. The member 75 comprises a generally cylindrical sidewall 80 which is coaxial with the base sidewall 30. The sidewall 30 is provided with internal screw thread formations 85 for engaging external screw thread formations on a corresponding container neck (not shown). The member 75 is also provided with a top-deck 90 which fits under the top deck 35.

A dispensing spout projects from the top deck 90 and passes through the aperture 40 and the top deck 35.

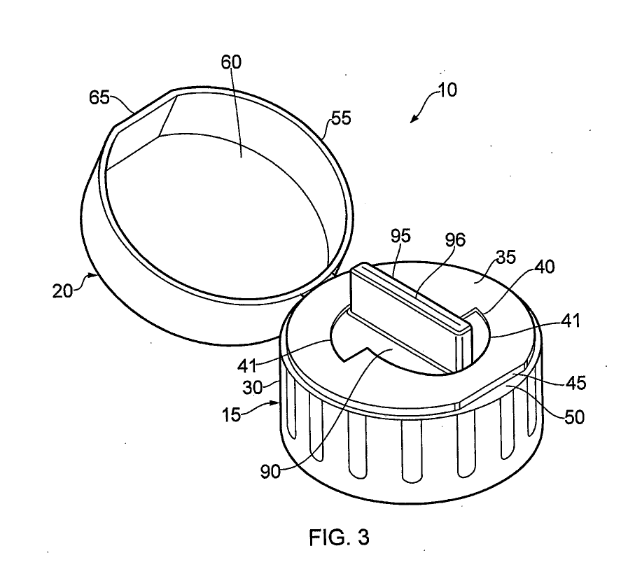

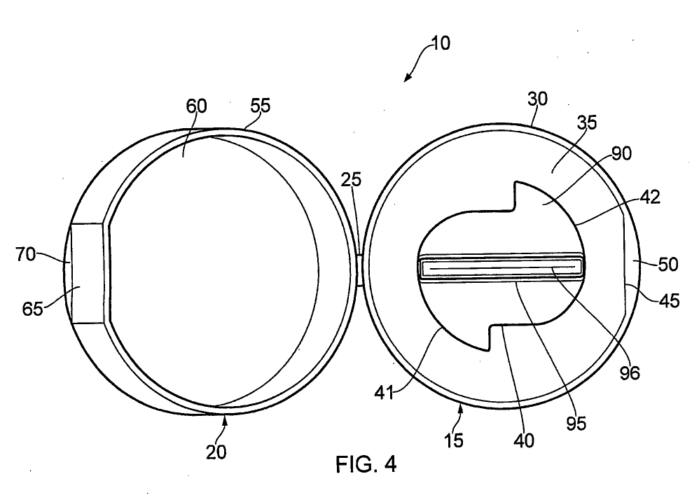

Referring now also to FIGS. 3 and 4, the dispensing spout 95 is shown projecting through the aperture 40.

The aperture 40 is generally oval except that the two opposed semi-circular end parts 41, 42 are offset radially.

FIGS. 3 and 4 show the dispensing spout 95 in an occluded position. The spout 95 is elongate and includes a central slot 96 which defines the orifice. In FIGS. 3 and 4 the spout 95 is shown in a relaxed position. The spout 95 extends between the aperture parts 41, 42 and thus is accommodated in the longest dimension of the aperture 40.

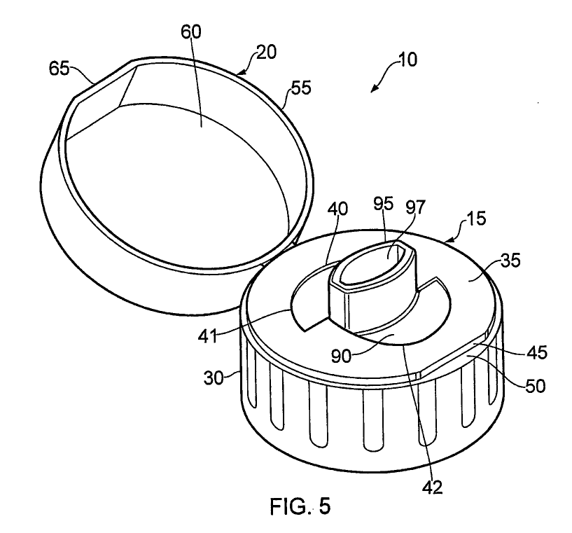

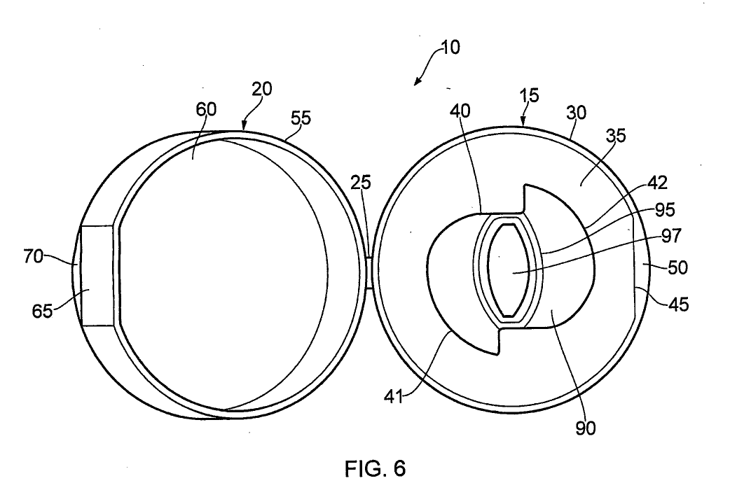

When dispensing is required the base 15 is rotated 90°. This movement causes the spout 95 to move along the inner ramp surface of the aperture, eventually arriving at the position shown in FIGS. 5 and 6 where the spout 95 is held in the shortest dimension of the aperture. The transition from the position shown in 3 and 4 to the position shown in FIGS. 5 and 6 causes the spout 95 to be deformed as forces are applied from either end of the spout along its length. This causes the spout 95 to ovalise so that the slit 96 opens to define the dispensing orifice 97. Therefore by compressing the spout along its long axis it is caused to deform and the walls either side of the slot 96 are forced apart along the entire height of the spout.

When dispensing is complete the above operation can be reversed or the base can be turned a further 90° so that the spout 95 again passes along the inner wall of the aperture and eventually the effective length of the aperture increases sufficiently for the spout to close and return to the relaxed position shown in FIGS. 3 and 4.

In this embodiment the inner closure member 75 is formed from a thermoplastic elastomer and the base 15 and lid 20 are formed from polypropylene.

The closure may have some means for defining the dispensing and occluded positions, such as some form of positive engagement features to indicate to a user the position has been reached.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A dispensing closure comprising a base and a lid joined together by a hinge, the base having a dispensing orifice defined by a deformable dispensing member, in which the dispensing member is movable from an open, dispensing position and a closed, occluded position, and in which the base is rotatable relative to the dispensing member to move it between the dispensing and occluded position.

2. A closure as claimed in claim 1, in which the dispensing member is relaxed in the open position and moveable to the closed position by deformation.

3. A closure as claimed in claim 1, in which the dispensing member is relaxed in the closed position and moveable to the open position by deformation.

4. A closure as claimed in claim 1, in which the base includes one or more ramps for causing the dispensing member to move between the dispensing and occluded positions.

5. A closure as claimed in claim 1, in which the dispensing member is elongate.

6. A closure as claimed in claim 5, in which the dispensing member is compressible along its long axis to move it between the dispensing and occluded positions.

7. A closure as claimed in claim 1, in which the dispensing member is tube-like.

8. A closure as claimed in claim 1, in which the dispensing member comprises a spout.

9. A closure as claimed in claim 1, in which the orifice is sealed in the closed position.

10. A closure as claimed in claim 1, in which the dispensing member is formed from an elastomeric material.

11. A closure as claimed in claim 1, in which the dispensing member is formed from a thermoplastic elastomer.

12. A closure as claimed in claim 1, in which the dispensing member is provided on an inner closure member.

13. A closure as claimed in claim 1, in which the base has an aperture through which the dispensing member projects.

14. A closure as claimed in claim 13, in which the aperture comprises, two opposed semicircular parts which are radially offset.

15. A container having a closure, the closure comprising a base and a lid joined together by a hinge, the base having a dispensing orifice defined by a deformable dispensing member, in which the dispensing member is movable from an open, dispensing position and a closed, occluded position, and in which the base is rotatable relative to the dispensing member to move it between the dispensing and occluded position.
